(19) United States
(12) Patent Application Publication
(10) Pub. No.: US 2012/0160393 A1
(43) Pub. Date: Jun. 28, 2012

(54) METHOD FOR MAKING BISTABLE NEMATIC LIQUID-CRYSTAL DEVICES

(76) Inventors: Sandrine Lamarque-Forget, Magny Les Hameaux (FR); Bertrand Pecout, Guyancourt (FR); Didier Gallaire, Orsay (FR)

(21) Appl. No.: 13/386,893

(22) PCT Filed: Jul. 23, 2009
(86) PCT No.: PCT/EP2009/059472

§ 371 Date: Jan. 24, 2012

(30) Foreign Application Priority Data
Jul. 25, 2008 (FR) 0855121

(51) Int. Cl. B32B 37/14

(52) U.S. Cl. 156/60

(57) ABSTRACT

The object of the invention is a method for making devices with bistable nematic liquid crystals, having a nematic liquid crystal layer placed between two plates, each plate including a strip, an electrode and an alignment layer for nematic liquid crystal, at least one of said alignment layers having low zenithal anchoring for said liquid crystal, small pre-tilt and medium or strong azimuthal anchoring, wherein said at least one of the alignment layers is prepared by depositing a solution comprising a polymer, said polymer is a copolymer or a terpolymer derived from vinyl chloride and vinyl ethers, said solution further comprising an additive, selected from the group formed by aromatic polyimides, precursors of the aromatic polyamic acid type or a mixture of these compounds.

### FIELD OF THE INVENTION

The present invention relates to the field of liquid crystal display devices and more particularly to the alignment layers used in bistable nematic liquid crystal displays.

### OBJECT OF THE INVENTION

More specifically, the main goal of the invention is the use of one or more additives with which the properties of alignment layers of polymeric type may be improved in bistable nematic liquid crystal displays.

### STATE OF THE ART

Liquid crystal display devices (LCDs) are increasingly used in display applications with constraints on volume, weight and electrical consumption. They are therefore found in all sorts of mobile applications, for example portable computers, electronic books, personal assistants and portable telephones.

### Operation of Standard Displays

In their simplest form, electrically controlled display devices comprise a liquid crystal material confined between two plates, at least one of which is transparent. Each plate includes a strip, often in glass, on which a conducting electrode has been deposited (the strip and electrode assembly is called a substrate) and then a so-called anchoring layer also called an alignment layer. This alignment layer may be subject to surface treatment which orientates the liquid crystal. The alignment layer exerts on the neighboring liquid crystal molecules, a return torque which tends to orient them parallel to a direction called an easy axis. The alignment layers are often made by depositing a polymer, brushed with a roller in order to create the direction of the easy axis. The latter most often is very close to the brushing direction. Further, the anchoring polymers should be soluble in order to be suitably applied on the substrate in order to suitably wet and cover the latter. Once the film is deposited, it should be insoluble in the liquid crystal material.

The thickness of the thereby formed cell is made constant by distributing between the strips, beads, the diameter of which is equal to the desired thickness (typically from 1 to 6 μm).

By applying a potential difference between the electrodes of both plates, the orientation of the liquid crystal changes under the action of the electric field. Because of the optical anisotropy of the crystal liquid, these changes in orientation modify the optical properties of the display depending on the amplitude of the applied field. All these so-called “conventional” displays, have a common characteristic: upon cutting-off the external electric field, the displayed information disappears more or less rapidly. Regardless of the field, the orientation of the molecules close to the alignment layer is set, almost parallel to the substrate. Upon cutting off the field, these set molecules reorient the other ones according to the equilibrium texture. The elasticity of the liquid crystal assisted by the strong anchoring of the molecules on the alignment layers causes disappearance of the deformation generated by the field, therefore of any information.

### Principle of Bistable Liquid Crystal Displays

A new generation of nematic so-called “bistable” displays appeared a few years ago: they operate by switching between two stable states in the absence of a field. The external electric field is only applied during the time required for having one state of the liquid crystal texture switch over to the other. In the absence of an electrical control signal, the display remains in the state. By its operating principle, this type of display consumes energy in proportion with the number of image changes; thus, when their frequency is lowered, the power required for operating the display tends to zero. This type of display is developing rapidly because of the expansion of the market of mobile devices.

Several types of bistable displays require that the liquid crystal molecules be able to change orientation in the vicinity of the plates and to easily pass from being parallel or quasi-parallel to perpendicular or quasi-perpendicular. The one developed by the ZBD corporation (G. P. Bryan-Brown et al. Nature, 399, 338 (1999)), is typical: in one of the bistable states, the molecules in the vicinity of the plate are on average parallel; in the other one they are perpendicular to it. Switching requires easy transition between both of the states.

For other displays, during switching, the electric field causes the molecules close to one or each of the two plates of the device to change from being quasi-parallel to practically perpendicular to the latter it is said that these devices switch by breakage of the anchoring. Two bistable nematic displays with breakage of anchoring using bistable surfaces were proposed by the Laboratoire de Physique des Sondes d'Orsay, (Solid State Physics Laboratory, Orsay) the stable state is selected after switching by a flexo-electric effect (FR 2 663 770), the other one by an electro-chiral effect (FR 2 657 699). Two bistable nematic displays with breakage of anchoring on monostable surfaces are being developed presently: the BiNem® display developed by NEMOPTIC in France (EP 0859970 and U.S. Pat. No. 6,327,017) or the SBiND display developed by LICET in Italy (EP 0 773 468, U.S. Pat. No. 5,995,173).

### Definition of the Notion of Anchoring and of Breakage of Anchoring

The notions of anchoring and breakage of anchoring of liquid crystal molecules on surfaces are very technical, it is possible to specify them.

Anchoring

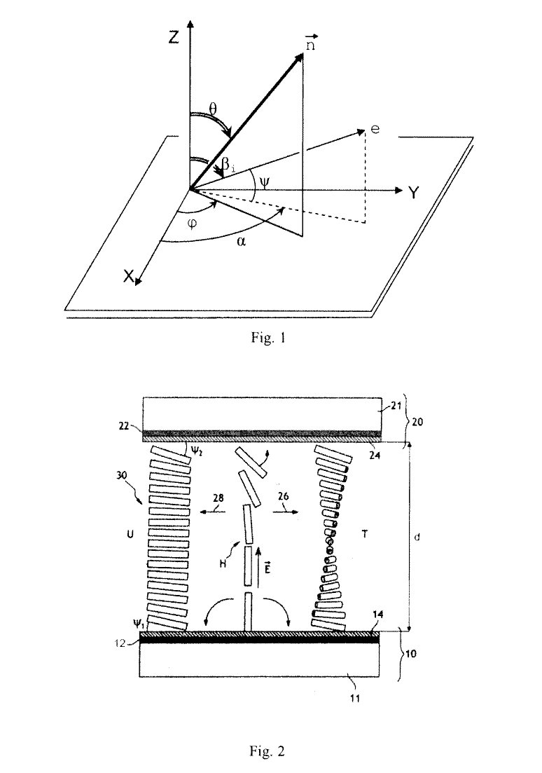

The orientation of liquid crystal molecules by surfaces, such as alignment layers, bears the name of anchoring. The source of the anchoring is the anisotropy of the interaction between the liquid crystal and the surface. The anchoring may be characterized by its energy and the preferential direction imposed by the surface to the neighboring liquid crystal molecules. This direction, called an easy axis, is described by the unit vector n̅ or by the zenithal θₒ and azimuthal φ_{c} angles in the Cartesian coordinate system with the axis z being perpendicular to the surface of the substrate (see FIG. 1). If the easy axis of the molecules of nematic liquid crystals is perpendicular to the substrate, the alignment is homeotropic, if it is parallel to the substrate, the alignment is planar. Between both of these cases, there is a so-called oblique alignment, described by the angle of the easy axis relatively to the normal to the surface of the substrate, or by its complementary angle, called an inclination or “pretilt” angle.

In the absence of any external influence, the molecules of the liquid crystal are oriented parallel to the easy axis in order to minimize the interaction energy with the surface. This energy (anchoring energy) may be written in a first approximation (A. Rapini and M. Papoular, J. Phys. (Fr)(C4, 30, 54-56 (1969)) as:

$$g ( θ , ϕ ) = \frac{{W}_{z}}{2} {sin}^{2} ( θ - {θ}_{0} ) + \frac{{W}_{a}}{2} {sin}^{2} ( ϕ - {ϕ}_{0} ) \qquad ( 1 )$$

wherein θ and φ are the zenithal angle and azimuthal angle of the molecules on the surface, W_{z} and Wₐ are the zenithal and azimuthal anchoring energy surface densities. To simplify, we shall call them anchoring energies. On most solid surfaces, the zenithal anchoring energy is larger than the azimuthal anchoring energy by one or two orders of magnitude. The azimuthal anchoring energy mainly depends on the anisotropy induced on the surface by the treatments.

The anchoring energy may also be given by the extrapolation length. This is the distance between the investigated surface and the position of a virtual surface with infinitely strong anchoring. By imposing an infinitely strong anchoring (it is possible to pivot the molecules located on this virtual surface), it induces the actual texture of the liquid crystal.

The zenithal extrapolation length Lz is proportional to the reciprocal of the anchoring energy Wz, according to the relationship:

Lz=k33/Wz wherein k33 is the elastic flexural deformation (<<bend>>) coefficient of the relevant liquid crystal.

The azimuthal extrapolation length La is proportional to the reciprocal of the anchoring energy Wa, according to the relationship:

La=k22/Wa wherein k22 is the elastic torsional deformation coefficient of the relevant liquid crystal.

It is considered that azimuthal anchoring is medium or strong if La<100 nm.

It is considered that zenithal anchoring is strong if Lz<15 nm and low if Lz>25 nm.

Typically, zenithal anchorings are stronger than azimuthal anchorings by one order of magnitude.

Certain materials of the polyimide type are used for the alignment layers of conventional displays following a method of the coating type, for example by flexography or <<flex-printing>>, followed by brushing, for example with a textile roller. The alignment layers obtained for conventional displays have high azimuthal and zenithal anchoring energy.

### Breakage of Anchoring.

Certain alignment layers may have low anchorings, for example low zenithal anchoring. In this case, it is possible to <<break>> the zenithal anchoring by means of an electric field with not very high amplitude, relatively.

The orientation of the liquid crystal molecules may be changed by means of external fields, either electric or magnetic fields. For example, for an electric field normal to the surface, the molecules with positive anisotropy are oriented along the field (θ=0°) in the volume of a cell where, without any field, they are flat (θ≅90°). On the surface, the zenithal angle decreases continuously depending on the field and for a field above the critical field E_{c}, θ becomes zero. It is said that zenithal anchoring is broken, because the molecules close to the surface undergo neither any anchoring torque, nor any electrical torque. The critical field is:

$${E}_{C} = \frac{{W}_{z}}{\sqrt{{K}_{33} Δɛ}} = \frac{1}{{L}_{z}} \sqrt{\frac{{K}_{33}}{Δɛ}} \qquad ( 2 )$$

wherein W₂ is the zenithal anchoring energy, Lz is the zenithal extrapolation length, K₃₃ is the elastic flexure coefficient and Δ∈ is the dielectric anisotropy of the liquid crystal.

This critical field is the one which has to be applied in order to obtain switching of the devices with breakage of zenithal anchoring.

With Lz=25 nm and a crystal liquid such that K33=15 pN and Δ∈=20∈₀ where ∈₀ is the vacuum dielectric constant, one obtains

Ec=12V/μm.

Thus, for low zenithal anchoring, Ec is typically less than 15V/μm at room temperature.

Thus, low zenithal anchoring may be characterized by the extrapolation length Lz (Lz>25 nm) or by the electric field Ec for breaking anchoring at room temperature (Ec<15V/μm) or by the corresponding breakage voltage Vc=Ec.d, with d being the thickness of the liquid crystal cell. For a cell with a thickness of 1.5 μm, one obtains Vc<22.5V.

The BiNem Type Display with Breakage of Anchoring

The BINEM® bistable display is schematically shown in FIG. 2; it uses two textures for which torsion differs by ±180° to ±15°. Typically the torsion differs from 150° to 180° in absolute value preferential but non-limiting alternative is to use a uniform or slightly twisted texture designated by U in which the molecules are substantially parallel with each other to within +/−20° and the other texture designated as T differs from the first by a torsion of about 180°.

The liquid crystal layer 30 is placed between two plates 20 and 12 which each include a strip 21 and 11, an electrode 22 and 12 (strip and electrode forming the substrate), and an alignment layer 24 and 14, deposited on the substrate, respectively.

The electrodes 22 and 12, usually transparent on at least one of the strips, allow application of an electric field E perpendicular to the plates 10 and 20 Generally, the conducting electrodes are made with a transparent conducting material called ITO (mixed Indium Tin Oxide), but other electrodes may be contemplated.

The liquid crystal layer 30 may advantageously consist of mixtures of liquid crystal molecules as described in patent U.S. Pat. No. 7,115,307 or patent application U.S. Ser. No. 11/397,506.

The layer 24 is an alignment layer used for standard displays: it has strong zenithal and azimuthal anchoring energy, and a <<pretilt>> or pre-inclination angle ψ2 relatively to the surface of the plate 20, close to 5°, typically between 4° and 7°.

The layer 14 is an alignment layer specific to the BiNem display: it has a medium or strong azimuthal anchoring energy, a low zenithal anchoring energy and a very small <<pretilt>> or pre-inclination angle ψ1 relatively to the surface of the plate 10, ψ1 <<1°, typically between 0° and 1°, preferentially between 0.05° and 0.5°.

The two ψ1 and ψ2<<pretilts>> are in the same direction.

The nematic liquid crysal 30 is chiralized with a spontaneous pitch p₀, selected to be close to four times the thickness d of the liquid crystal cell in order to equalize the energies of both textures.

d/p0=0.25±0.05

Without any field, the textures U and T are states of minimum energy: the cell is bistable.

The textures U and T are topologically distinct: a continuous transition between them is impossible without breaking the anchoring.

Under a strong field, a quasi homeotropic structure (H) is obtained, the anchoring of the molecules is broken at least on one of the plates: the neighboring molecules are normal to it. At the end of the control pulse, the cell returns to either one of the textures, depending on the rate of return to equilibrium of the molecules close to the surface, for which anchoring was not broken. A slow return gives the state U by elastic coupling 28 between the molecules close to both surfaces, a rapid return gives the state T by hydrodynamic coupling 26.

Adjunction of polarizers on each of the strips 11 and 21 typically but in a non-limiting way outside the device allows association with each texture of an optical state, for example dark for U and clear for T or vice versa, depending on the angles of both polarizers relatively to the anchoring directions.

The 3 addressing modes developed for standard liquid crystals (direct, multiplexed, active modes) may be used for the bistable devices with breakage of anchoring according to the invention. The most common addressing mode of the device according to the invention is multiplexed passive addressing, but active addressing by means of thin film transistors is also possible. In the active and passive multiplexed modes, the device according to the invention is a matrix screen formed with n times m screen elements called pixels, n being the number of lines and m being the number of columns, and addressing is carried out line per line.

Technical Problems Encountered with the Low Zenithal Anchoring Layers for the Binem Display According to the State of the Art

Means liar ensuring azimuthal anchoring with relatively high energy and zenithal anchoring with relatively low energy have already been described in patents U.S. Pat. No. 7,087,270 and U.S. Pat. No. 7,067,180 (or EP1369739).

With the polymer of general formula (I), as described in U.S. Pat. No. 7,087,270 and U.S. Pat. No. 7,067,180, by itself, it is possible to make bistable nematic liquid crystal devices with breakage of anchoring. The polymer may be a copolymer or a terpolymer obtained by recurrence of the unit of the following formula:

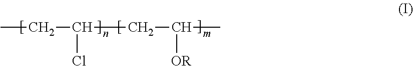

with R representing an alkyl or aryl radical, either substituted or not, and n and m may vary from 0 to 1.

In order to make the solution which will be deposited, the polymeric materials are diluted in solvents, for example ketone-based solvents, such as methylethylketone, other solvents such as dimethylformamide, N-methyl pyrrolidone or solvents based on butoxy ethanol, or mixtures of these solvents.

However, the properties of the layer obtained from the deposit of these polymers are not sufficiently reproducible for obtaining high yields on a production line. The anchoring properties vary over the surface of the alignment layer and in the temperature range of use (typically 0° C.-50° C., or 10° C.-40° C.)

The present invention is an enhancement of the invention described in patents U.S. Pat. No. 7,087,270 and U.S. Pat. No. 7,067,180.

The object of the present invention is a method for making bistable nematic liquid crystal devices, having a nematic liquid crystal layer place between two plates (20,10), each plate including a strip (21,11), an electrode (22,12) (strip and electrode forming the subtrate) and an alignment layer for a nematic liquid crystal (24,14), at least one said alignment layers having:
low zenithal anchoring for said liquid crystal such that the breakage electric field is less than 15V/μm at room temperature;
a pretilt angle comprised between 0° and 1°; and
medium or strong azimuthal anchoring characterized by an extrapolation length La100 nm;
   wherein said at least one of the alignment layers is prepared by depositing a solution comprising a polymer, said polymer is a copolymer or a terpolymer derived from vinyl chloride and vinyl ethers of formula I

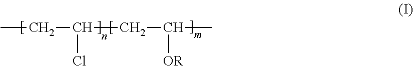

wherein
R represents an alkyl, alkoyl or aryl group, optionally substituted, preferably R represents the radical —CH₂CH(CH₃)₂,
n and m vary from 0 to 1, with preferably comprised values for n: 0,5<n<0.9 and for m: 0.1<m<0.5
characterized in that said solution further comprises an additive, said additive being selected from the group formed by aromatic polyimides, precursors of the aromatic polyamic acid type or a mixture of these compounds, the mass percentage of the additive varying from 5% to 30% by weight, based on the total weight of said additive and of said polymer derived from vinyl chloride and vinyl ethers of formula I.

In other words, the object of the present invention is a method for enhancing bistable nematic liquid crystal devices, having a nematic liquid crystal layer placed between two plates (20,10), each plate including a strip (21,11), an electrode (22,12) (strip and electrode forming the substrate) and an alignment layer for a nematic liquid crystal (24,14), at least one of said alignment layers having:
low zenithal anchoring for said liquid crystal such that the breakage electric field is less than 15V/μm at room temperature
a pretilt angle comprised between 0° and 1°
medium or strong azimuthal anchoring characterized by an extrapolation length La<100 nm
   wherein said at least one of the alignment layers is prepared by depositing a solution comprising a polymer, said polymer is a copolymer or a terpolymer derived from vinyl chloride and vinyl ethers of formula I

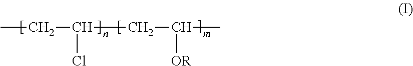

wherein
R represents an alkyl, alkoyl or aryl radical, optionally substituted, preferably R represents the radical —CH₂CH(CH₃)₂,
n and m vary from 0 to 1, with preferably values comprised for n: 0.5<n<0.9 and for m: 0.1<m<0.5
said enhancement consisting of using an additive in the solution containing the polymer I, said additive being selected from the group formed by aromatic polyimides, precursors of the aromatic polyamic acid typo or a mixture of these compounds the mass percentage of the additive varying from 5% to 30% by weight, based on the total weight of said additive and of said polymer derived 2.0 from vinyl chloride and vinyl ethers of formula I.

This application describes the making of an alignment layer, over at least one of the substrates, originating from deposition of a solution consisting of a majority of copolymers and terpolymers specially selected on the basis of poly(vinyl chloride-co-vinyl alkyl ether) or polyvinyl chloride-co-vinyl aryl ether) or polyvinyl chloride-co-vinyl alkoyl ether) as described in patents U.S. Pat. No. 7,087,270 and U.S. Pat. No. 7,067,180, to which is added an additive, in order to produce the solution which will be deposited, the polymeric materials and the additive are diluted in solvents, for example ketones such as methylethylketone or other solvents such as dimethylformamide, N-methylpyrrolidone or butoxy ethanol or mixtures of these solvents. The final deposited layer has a homogenous surface.

The object of the invention is also the coating solution for an alignment layer having, once deposited on the substrate of a bistable nematic liquid crystal device:
low zenithal anchoring for said liquid crystal such that the breakage electric field is less than 1,5V/μm at room temperature
a pretilt angle comprised between 0° and 1°
medium or strong azimuthal anchoring characterized by an extrapolation length La<100 nm
   comprising a polymer, said polymer is a copolymer or a terpolymer derived from vinyl chloride and vinyl ethers of formula I

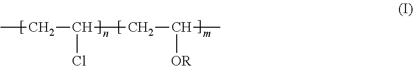

wherein
R represents an alkyl, alkoyl, or aryl radical, optionally substituted, preferably R represents the radical —CH₂CH(CH₃)₂,
n and in vary from 0 to 1, with preferably values comprised for n: 0.5<n<0.9 and for m: 0.1<m<0.5
characterized in that it further comprises an additive, said additive being selected from the group formed by aromatic polyimides, precursors of the aromatic polyamic acid type or a mixture of these compounds, the mass percentage of the additive varying from 5% to 30% by weight, based on the total weight of said additive and of said polymer derived from vinyl chloride and vinyl ethers of formula I.

### DEFINITIONS

Within the scope of the present invention, the term of <<alkyl>> designates a straight or branched chain hydrocarbon radical containing from 1 to 12 carbon atoms, advantageously from 1 to 6 carbon atoms, still more advantageously from 1 to 4 carbon atoms, such as methyl, ethyl, propyl, isopropyl and butyl.

Within the scope of the present invention the term of <<alkoyl>> designates a carbonyl-CO-alkyl radical, in which the alkyl radical fits the definition given earlier.

Within the scope of the present invention, the term of <<aryl>> designates an aromatic carbocyclic radical containing from 6 to 11 carbon atoms, such as phenyl and biphenyl radicals, optionally substituted with a C₁-C₁₂ alkyl substituent for example: benzyl, phenethyl, phenyl-propyl, phenyl-butyl, phenyl-pentyl, phenyl-hexyl, phenyl-heptyl and phenyl-octyl. These aryl radicals substituted with an C₁-C₁₂ alkyl are further designated as <<aralkyl>>.

### Polymer I

The polymer (I) described in patents U.S. Pat. No. 7,087,270 and U.S. Pat. No. 7,067,180, already by itself allows the making of bistable nematic crystal devices by breakage of anchoring. The polymer may be a copolymer or a terpolymer derived from the unit of formula (I) (vinyl chloride-co-vinyl alkyl or aryl or alkoyl ether):

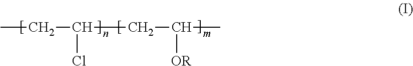

wherein R represents an alkyl, alkoyl or aryl radical, either substituted or not, and n and m vary from 0 to 1. The substituents are advantageously selected from the group formed by linear or branched C₁-C₁₂ alkyls.

According to an advantageous alternative of the invention, R represents the —CH₂CH(CH₃)₂ radical.

In formula I, n and m may vary from 0 to 1, with preferably values comprised for n: 0.5<n<0.9 and for m: 0.1<m<0.5.

With terpolymers derived from the unit of formula (I) and from another co-monomer, it is also possible to obtain anchoring layers with low zenithal anchoring energy. As an example, the co-monomer may be selected from the group formed by ether or ester derivatives of vinyl alcohol.

In an alternative of the invention, the polymer is a terpolymer based on poly(vinyl chloride)-poly(vinyl isobutyl ether) and on another co-monomer derived from vinyl alcohol.

### The Additive

The additive is an aromatic polyimide (or a mixture of aromatic polyimides) or a precursor of the aromatic polyamic acid type (or a mixture of precursors of the aromatic polyamic acid type).

The term of polyimide or polyamic acid designates a polymer obtained as a result of a polycondensation reaction between a dianhydride or the corresponding tetra-acid and a diamine.

According to an advantageous alternative of the invention, the polyimide or the polyamic acid is obtained by polycondensation of an aromatic dianhydride or of the corresponding tetra-acid, and of a diamine.

In particular the dianhydride is of formula (II) (PMDA):

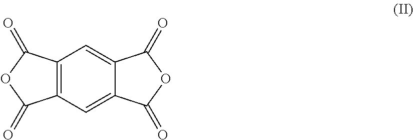

The corresponding tetra-acid will then be of formula (IIa):

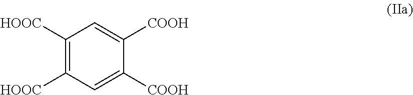

according to an advantageous alternative of the invention, the diamine is aromatic.
In particular, the diamine is an aromatic diamine. It more advantageously fits the following formula (III):

H₂N—Ar₁—B—Ar₂—NH₂ (III)

wherein

Ar₁ and Ar₂ represent phenyl radicals, optionally substituted with one or more radicals selected from the group formed by hydroxyl, C₁-C₁₂ alkoxy and C₁-C₁₂ O-aralkyl radicals, and

B represents a C₁-C₁₂ alkyl radical or a C₁-C₁₂ dialkoxy radical optionally substituted with one or more trifluoromethyl radicals, preferably a C₁-C₁₂ dialkoxy radical, optionally substituted with one or more trifluoromethyl radicals. The radical B is more advantageously a C₁-C₆ alkyl radical substituted with one or more trifluoromethyl radicals, or a C₃-C₈ dialkoxy radical.

The radical B and the unit derived from the aromatic tetra-acid may be in the ortho, meta or pain position. They are advantageously in the para or meta position.

The radicals Ar1 and Ar2 are advantageously identical. In this case, the Ar1 and Ar2 radicals are even more advantageously selected from the group formed by a phenyl radical, non-substituted or substituted with one or more radicals independently selected from the group formed by hydroxyl, C₁-C₁₂ alkoxy and C₁-C₁₂ O-aralkyl radicals. More particularly, Ar1 and Ar2 are selected from the group formed by a phenyl radical, non-substituted or substituted in the ortho position (relatively to the amine function NH₂) with a substituent OX, wherein X represents a hydrogen atom, a C₁-C₁₂ alkyl radical or a C₁-C₁₂ aralkyl radical. In particular, X represents a hydrogen atom or a phenyl-octyl radical.

The Ar1 and Ar2 radicals may be different. In this case, they are advantageously selected from the group formed by phenyl radicals, non-substituted or substituted with one or more radicals independently selected from the group formed by hydroxyl, C₁-C₁₂ alkoxy and C₁-C₁₂ O-aralkyl radicals, at least one of the Ar1 and Ar2 radicals representing a substituted phenyl radical. Advantageously, Ar1 represents a phenyl radical substituted with a substituent OX and Ar2 represents a phenyl radical substituted with a substituent OY, X and Y representing independently of each other, a hydrogen atom, a C₁-C₁₂ alkyl or a C₁-C₁₂ aralkyl. The substituents OX and OY are advantageously and respectively in the ortho position relatively to the amine function NH₂.

A preferred diamine is a diamine of formula (IV):

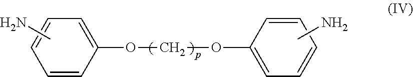

wherein p is an integer which varies from 1 to 12, advantageously from 2 to 8, more advantageously p has the value 5; and wherein both substituents NH₂ are preferably in the para position.

Another preferred diamine is a diamine of formula (V):

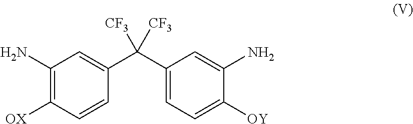

wherein X and Y represent independently of each other, a hydrogen atom, a C₁-C₁₂ alkyl or a C₁-C₁₂ aralkyl. In particular, both radicals X and Y each represent a hydrogen atom. In another particular case, both radicals X and Y each represent a phenyl-octyl radical.

According to a preferred alternative of the invention, the dianhydride is of formula (II) (and the corresponding tetra-acid will then be of formula (IIa)) and the diamine fits formula (III), in particular the diamine fits formula (IV) or (V). In particular, the polyimide or the polyamic acid used as an additive within the scope of the invention, is derived from a monomer fitting the following formula (VI)

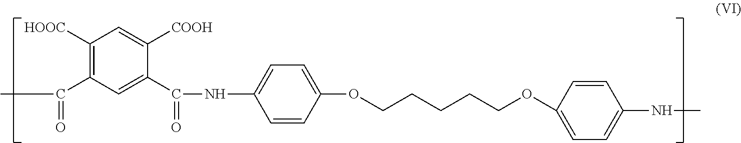

Its polyimide, form is (VIa)

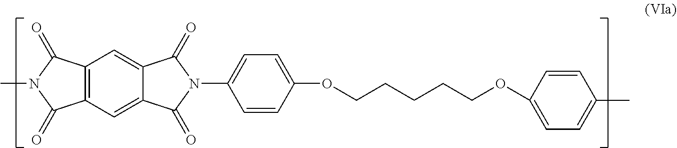

This latter molecule was described in patent EP 0 911 680.
Another polyimide is derived from a monomer of formula (VII):

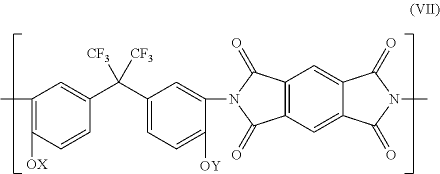

X and Y represent, independently of each other, a hydrogen atom, a C₁-C₁₂ alkyl or a C₁-C₁₂ aralkyl. In particular both radicals X and Y represent a hydrogen atom. In another particular case, both radicals X and Y represent a phenyl-octyl radical.

The additive may also be characterized by its physical properties. In particular, the additive by itself may allow the making of a strong (zenithal and azimuthal) anchoring layer of the liquid crystal. More particularly, the additive by itself may allow the making of a strong (zenithal and azimuthal) anchoring layer of the liquid crystal having a pre-tilt of less than 5°.

The additive may be a polyimide (or a mixture of polyimides) or a commercial precursor of the polyamic acid type (or a mixture of precursors), i.e. so as to allow the making as such of alignment layers with strong anchoring, for example those available from Nissan Chemicals under the designations RN1199, RN1744, SE5291, SE7992, SE7492, SE8313.

Surprisingly, addition to a polymer of formula (I) with which low zenithal anchoring may be obtained, of an additive producing by itself a strong (azimuthal and zenithal) anchoring layer, allows the low zenithal anchoring properties generated by the polymer (I) to be retained while improving the coating method and the performances of the display with integration of the layer according to the invention (i.e. said polymer (I) and the additive according to the invention). Mixing of both compounds, polymer (I) and additive, is carried out in the solution which will be deposited.

The mass percentage of the additive, in the coating solution, and also in the deposited layer, varies from 5% to 30% by weight, based on the total weight of said additive and of said polymer derived from vinyl chloride and vinyl ethers of formula I. According to an advantageous alternative, the mass percentage of said additive varies from 10% to 20% by weight, based on the total weight of said additive and of said polymer derived from vinyl chloride and vinyl ethers of formula I.

### Method for Depositing the Polymer I and the Additive According to the Invention

Deposition of the alignment layer comprising the polymer I and the additive is accomplished from a solution comprising said polymer and additive and suitable solvents. These solvents for example are ketones such as methylethylketone or other solvents such as dimethylformamide, N-methyl pyrrolidone or butoxy ethanol or mixtures of these solvents.

From the material (polymer I and additive) in solution in solvents, the deposition of the alignment layer is typically carried out according to the following steps (the numerical values are given as examples but are not limiting):

### *Step 1: a Deposition Designated as <<Coating>>

The solution is deposited on the exposed substrate (or on the substrate covered with a hardening layer, see later on) by centrifugation (for example: rate: 3,000 rpm, acceleration: 3,000 rpm/s, duration: 8 s-11 s) or by other methods such flexography (flex-printing), used in an industrial environment.

### Step 2: Smoothing Designated as <<Leveling>>

Just after the deposition step, the substrate with the deposited layer is left as such for between a few seconds and a few minutes, so that the layer is homogenized in thickness.

### Step 3: Evaporation of the Solvent Designated as <<Pre-Curing>>

The evaporation of the solvent is carried out by annealing, advantageously between about 50° C. and 80° C. for a few minutes.

### Step 4: Stabilization by Thermal Annealing Designated as Curing>>

The substrate with the deposited layer is then thermally stabilized with annealing advantageously between 150° C. and 250° C. for a few hours, preferentially between 130° C. and 190° C.

The layer obtained at this stage, from the deposit of the solution comprising the polymer I and the additive, will be designated as Ladd. This layer is of small thickness, typically between 1 nm and 50 nm, preferentially between 1 nm and 10 nm as a comparison, conventional alignment layers have a thickness which generally vary from 40 nm to 80 nm).

According to an alternative of the invention, the Ladd layer may be insolated with ultraviolet radiation (UV) of a wavelength advantageously comprised between 180 nm and 380 nm. However, by using the additive according to the invention, it is possible in many cases to do without the ultraviolet insolation step.

### Step 5: Brushing

The Ladd layer is then treated so as to be able to align the liquid crystal molecules. Typically, this is brushing (<<rubbing>>) by friction with a textile for example velvet, roller. This friction with a textile roller from the known art, is applied on the Ladd layer in order to impose to it an azimuthal orientation which will induce medium or strong azimuthal anchoring of the liquid crystal.

The most important steps of the method are the deposition (step 1), the annealing (step 4) and the brushing (step 5).

With the method it is possible to obtain an alignment layer of low zenithal anchoring, of strong or medium azimuthal anchoring and of a controlled pre-tilt angle comprised between 0° and 1°. The zenithal and azimuthal anchoring energies as well as the pre-tilt may be changed in a controlled way with the parameters of the method: solid concentration of the materials in the solution, deposition, heat treatments, optionally UV treatment, brushing.

### Final Characteristics of the Alignment Layer According to the Invention

With the brushed Ladd alignment layer comprising the polymer I and the additive according to the invention, it is possible to achieve:
low zenithal anchoring characterized either by L_{Z}>25 nm or by an anchoring breakage field Ec of less than 15V/μm at room temperature
medium or strong azimuthal anchoring (Lₐ<100 nm);
small pre-tilt: between 0° and 1°, advantageously between 0.05° and 0.5°
   Said alignment layer according to the invention advantageously has a small thickness which varies from 1 nm to 10 nm.

The alignment layer according to the invention, comprising the polymer I and the additive, further has the following advantages:
a widened operating temperature range, i.e. the BiNem device made with an alignment layer according to the invention properly displays over the whole of the cell any image over a temperature range at least equal to [5° C.; 40° C.], or even above.

When the layer is associated with certain specific liquid crystal mixtures, this operating temperature range may be shifted towards low temperatures, for example [−20° C.; 5° C.], which is required by users for certain applications of the display.
better robustness and reproducibility on an industrial production line.

### An Alternative of the Invention: Use of a Planarizing Hardening Layer

Before the step for depositing the solution containing the polymer I and the additive, it may be advantageous to deposit beforehand on the substrate (consisting of the glass strip and of the electrode), a hardening layer (<<hardcoat>>), which we shall designate as Lhard, a standard in the LCD industry. This layer is deposited according to the same deposition methods as for the alignment layer, i.e. for example with a whirler or by flexography.

With this hardening layer it is possible to reduce the risks of short-circuit with the tips of the conducting electrode, typically of ITO (Indium Tin Oxide). This layer carries out planarization and masks the ITO tips capable of causing short-circuits.

Further, surprisingly, the use of such a hardening layer provides the following advantages for carrying out the invention:
reinforcement of the azimuthal anchoring
the fact of making the method not very dependent on the type of ITO used

This Lhard hardening layer, generally but in a non-limiting way, based on SiO₂ and TiO₂, may for example be ordered from Nissan Chemicals (designations A-2014, AT-201, AT-732, AT-720A, AT-902) or from CARDINAL (designations SP3070 for example). With these products, it is possible to select the proportion of TiO₂ and SiO₂ in the material.

According to an alternative use of a hardening layer, the latter may be annealed after its deposition (after having been pre-baked at a temperature advantageously varying from 50° C. to 120° C. in order to allow evaporation of the solvent) at a temperature typically comprised between 150° C. and 350° C.

According to an alternative use of a hardening layer, a UV treatment is carried out at a wavelength advantageously comprised between 300 nm and 400 nm, typically 365 nm.

As a result of many experiments, the inventors have shown that all the <<hardeoats>> available commercially, are not compatible with the layer according to the invention. The [Lhard+Ladd] stack should in fine have substantially the same properties, in terms of zenithal anchoring and pre-tilt, than the layer according to the invention alone, which is not the case for all the commercial hardcoats. Indeed, the use of a hardening layer, which reinforces azimuthal anchoring, should slightly or not reinforce, zenithal anchoring, which should remain low, and should not result in a pre-tilt angle, measured at the interface between the alignment layer according to the invention and the liquid crystal, outside the range of values allowing the switching of the Binem type device.

The inventors have shown that hardening layers comprising a SiO₂/TiO₂ mixture, in said mixture the proportion of each of the oxides varies from 0% to 100% by weight, based on the total weight of the mixture, are compatible with the alignment layer according to the invention. Therefore according to an advantageous alternative, the Lhard hardening layer comprises a SiO₂/TiO₂ mixture.

According to another advantageous alternative, the thickness of this Lhard layer is comprised between 15 nm and 75 nm, preferentially between 15 nm and 50 nm.

Of course when Ladd is deposited on the Lhard hardening layer, the total thickness of the deposited stack on the substrate is the sum of the thicknesses of Lhard and of Ladd.

### EXEMPLARY EMBODIMENTS ACCORDING TO THE INVENTION

### Making the Liquid Crystal Cell

For the examples which will follow, a BiNem® type device is made in the following way: the nematic liquid crystal is placed between two glass strips coated with a conducting layer of indium tin oxide, making up the substrates. One of the substrates bears an alignment layer giving oblique anchoring and strong (zenithal and azimuthal) anchoring energy. Here this layer is a standard layer marketed by Nissan Chemical under reference SE3510. The other substrate bears an alignment layer according to the invention giving monostable anchoring with a small pre-tilt angle, low zenithal anchoring energy and medium or strong azimuthal anchoring energy. The device is filled with nematic liquid crystal liar example as described in patent EP 1 599 562. The thickness of the liquid crystal cells made is 1.5 μm.

### Characteristics of the Anchoring Layer According to the Invention

Measuring La, the azimuthal extrapolation length is a standard measurement (see for example E. Polossat and I. Dozov (1996) Mol. Cryst. Liq. Cryst. 282:223-233)

The small pre-tilt ψ of less than 1° may be measured with a method described in the reference <<Technique for local pretilt measurement in nematic liquid crystals>> S. Lamarque-Forget et al, Jpn. J. Apple Phys., 40, 349-351 (2001). The inventors have also specially developed a method which allows indirect measurement of the pre-tilt but directly on the liquid crystal cell of the BiNem type.

The breakage voltage Vc may be measured for example by means of an electro-optical method carried out on a functional BiNem cell, i.e. capable of switching from the texture U to the texture T and vice versa.

Vc is the voltage from which low anchoring was broken at the surface of the device. The device initially in T after the selection signal switches to U from this threshold voltage Vc.

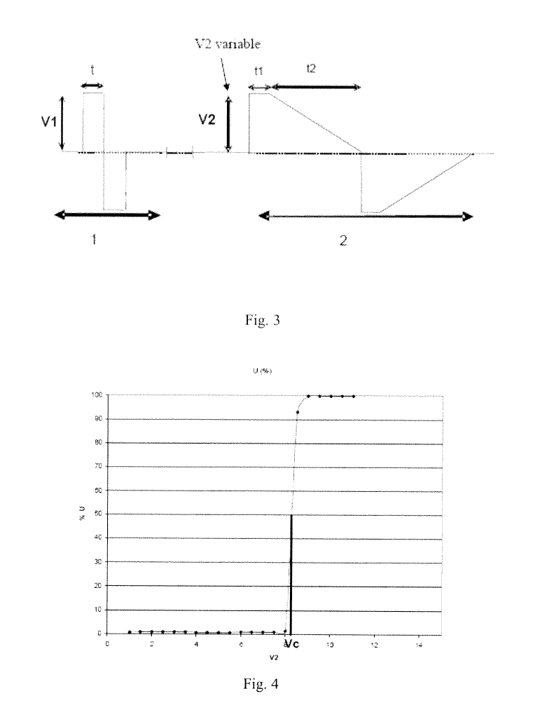

In order to measure this voltage Vc, an initialization electric signal (FIG. 3, 1) which is intended to switch the cell into the texture T, is first applied to the BiNem cell, and a so-called <<ramp>> acquisition electric signal (FIGS. 3, 2) is then applied, the amplitude V2 of which is varied. For a certain value of V2, the cell will switch to the texture U. Vc is defined as the signal corresponding to 50% of the cell in U (medium voltage, see FIG. 4) after the ramp.

Indeed, taking into account the signals applied for measuring Vc (a very long signal of the ramp type), hydrodynamic flow is negligible, only the elastic relaxation of the texture counts. If the initial texture is I and if V2 is less than the breakage voltage Vc, the final texture after applying the electric signal is the initial texture T. As soon as the voltage V2 is larger than or equal to Vc, zenithal anchoring is broken and the liquid crystal elastically relaxes into a uniform texture.

### Products and Notations

The polymer I used in the following examples is a copolymer made up from vinyl chloride and vinyl isobutyl ether, derived from the following unit:

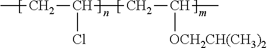

The additives used are:

A:

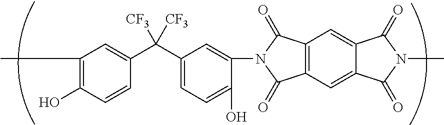

B:

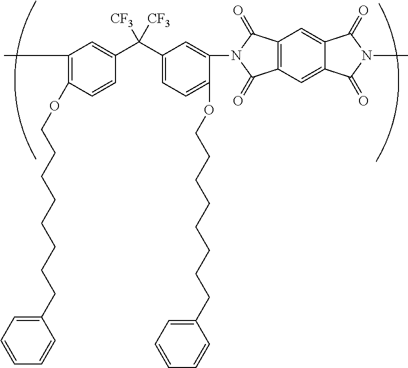

C:

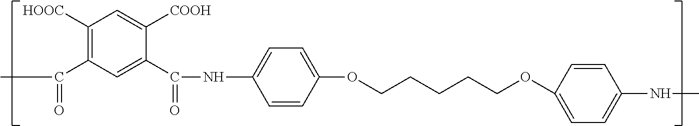

Let x be: the mass % of polymer II in the coating solution
Let y be: the mass % of the additive in the coating solution
T is defined as T=y/(x+y)

### Example 1

### Additive A

A solution is prepared containing the polymer I, the polyimide A additive as well as suitable solvents such as NMP and 2-butoxy-ethanol. The proportion of the additive is such that x=0.31%, i.e. T=15%.

The solution is deposited by means of a whirler, annealed at 170° C. for 4 hours and then the obtained layer is brushed, in order to form an alignment layer with low zenithal anchoring energy according to the present invention. A BiNem® device is obtained according to the general principle described earlier.

The measured characteristics of the layer at room temperature are:

Lₐ>100 nm,Vc=9.5 V,Ec=Vc/d=6.3 V/μm,Lz=30 nm and ψ=0.40°

### Example 2

### Additive B

A solution is prepared containing the polymer I, the polyimide B additive as well as suitable solvents. The proportion of the additive is such that: x=0.30%, T=15%.

The solution is deposited by means of a whirler, annealed at 170° C. for 4 hours and then the obtained layer is brushed, in order to form an alignment layer with low zenithal anchoring energy. A BiNem® device is obtained according to the general principle described earlier.

The measured characteristics of the layer at room temperature are:

Lₐ>100 nm,Vc8.8 V,Ec=Vc/d=5.85 V/μm Lz=32 nm and ψ=0.32°

### Example 3

### Additive C

A solution is prepared containing the polymer I, the polyimide C additive as well as suitable solvents. The solution is deposited by flexography, annealed at 170° C. for 4 hours and then the obtained layer is brushed, in order to form an alignment layer with low zenithal anchoring energy. A BiNem® device is obtained according to the general principle described earlier.

The measured characteristics of the layer at room temperature are:
For x=0.76%, T=10%,

Lₐ>100 nm,Vc=7.9 V,Ec=Vc/d=5.2 V/μm Lz=35.9 nm and ψ=0.28°

For x=0.72%, T=15%,

Lₐ>100 nm,Vc=7.8 V,Ec=Vc/d=5.2 V/μm Lz=36.1 nm and ψ=0.35°

For x=0.68%, T=20%,

Lₐ>100 nm,Vc=8.3 V,Ec=Vc/d 5.5 V/μm Lz=34.2 nm and ψ=0.38°

### Example 4

### Additive C and Hardening Layer

A planarization hardening layer from Nissan with reference AT720, consisting of a SiO₂/TiO₂ mixture with a thickness of 20 nm is deposited by flexography on the substrate. It is then annealed at 80° C. for 30 min (pre-curing) and then at 300° C. for 20 min. Next the alignment layer with low zenithal anchoring is deposited by flexography over the hardening layer, by substantially using the same parameters as when it is deposited directly on the substrate.

The measured characteristics of the layer at room temperature are:

Lₐ>100 nm,Vc=8.8V,Fc=Vc/d=5.85 V/μm and ω=0.15°

The inventors have shown by various experiments that the proportion of additive may vary between 0.5% and 30%, preferentially between 10% and 20% by weight, based on the total weight of the polymer and of the additive.

### Examples

### Deposition by Flexography of Polymer I/Additive C

For x=0.67%, T-21%,

Lₐ>100 nm,Vc=9.41 V,Ec Vc/d=6.3 V/μm,Lz=30.0 nm and ψ=0.50°

For x=0.72%, T=1.5%,

Lₐ>100 nm,Vc=8.71 V,Ec==Vc/d=5.8 V/μm,Lz=32.45 nm and ψ=0.145°

For x=0.76%, T=10%,

Lₐ>100 nm,Vc 8.9 V,Ec=Vc/d=5.9 V/μm,Lz=31.9 nm and ψ=0.06°

Of course, the present invention is not limited to the particular embodiments which have just been described but extends to all the alternatives which comply with the spirit thereof.

1.-17. (canceled)

8. A method for making devices with bistable nematic liquid crystals, having a nematic liquid crystal layer placed between two plates (20,10), each plate including a strip (21,11), an electrode (22,12) (strip and electrode form the substrate) and an alignment layer for nematic liquid crystal (24,14), at least one of said alignment layers having:
low zenithal anchoring for said liquid crystal such that the breakage electric field is less than 15V/μm at room temperature;
a pre-tilt angle comprised between 0° and 1°; and
medium or strong azimuthal anchoring characterized by an extrapolation length La<100 nm;
wherein said at least one of the alignment layers is prepared by depositing a solution comprising a polymer, said polymer is a copolymer or a terpolymer derived from vinyl chloride and vinyl ethers of formula I 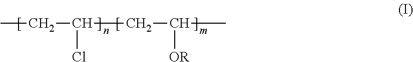
wherein
R represents an alkyl, alkoyl or aryl radical, optionally substituted,
n and m vary from 0 to 1,
wherein said solution further comprises an additive, said additive being selected from the group formed by aromatic polyimides, precursors of the aromatic polyamic acid type or a mixture of these compounds, the mass percentage of the additive varying from 5% to 30% by weight, based on the total weight of said additive and of said polymer derived from vinyl chloride and vinyl ethers of formula I.

19. The method according to claim 18, wherein said polymer is a copolymer or a terpolymer derived from vinyl chloride and vinyl ethers of formula I wherein R represents the radical —CH₂CH(CH₃)₂.

20. The method according to claim 18, wherein said polymer is a copolymer or a terpolymer derived from vinyl chloride and vinyl ethers of formula I wherein n is comprised in the range: 0.5<n<0.9.

21. The method according to claim 18, wherein said polymer is a copolymer or a terpolymer derived from vinyl chloride and vinyl ethers of formula I wherein m is comprised in the range: 0.1<m<0.5.

22. The method according to claim 18, wherein the mass percentage of said additive varies from 10% to 20% by weight, based on the total weight of said additive and of said polymer derived from vinyl chloride and vinyl ethers of formula I.

23. The method according to claim 18, wherein said at least one of the alignment layers has a pre-tilt angle comprised between 0.05° and 0.5°.

24. The method according to claim 18, wherein said at least one of the alignment layers has a thickness varying from 1 nm to 10 nm.

25. The method according to claim 18, wherein the polyimide or polyamic acid is obtained by polycondensation of an aromatic dianhydride or of the corresponding tetra-acid, and of a diamine.

26. The method according to claim 25, wherein the dianhydride is of formula (II):

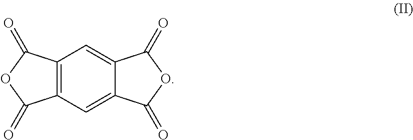

27. The method according to claim 18, wherein the polyamide or the polyamic acid is obtained by polycondensation of a dianhydride, or of the corresponding tetra-acid, and of an aromatic diamine.

28. The method according to claim 27, wherein the diamine is aromatic.

29. The method according to elm 28, wherein the diamine is aromatic, of formula (III):
H₂N—Ar₁—B—Ar₂₁—NH₂ (III)
wherein
Ar₁ and Ar₂ represent phenyl radicals, and
B represents a C₁-C₁₂ alkyl radical or a C₁-C₁₂ dialkoxy radical, optionally substituted with one or more trifluoromethyl radicals, preferably a C₁-C₁₂ dialkoxy radical, optionally substituted with one or more trifluoromethyl radicals.

30. The method according to claim 29, wherein Ar₁ and Ar₂ represent phenyl radicals substituted with one or more radicals selected from the group formed by hydroxyl, C₁-C₁₂ alkoxy and C₁-C₁₂ O-aralkyl radicals.

31. The method according to claim 29, wherein Ar1 and Ar2 are identical.

32. The method according to claim 29, wherein B represents a C₁-C₁₂ alkyl radical or a C₁-C₁₂ dialkoxy radical, substituted with one or more trifluoromethyl radicals.

33. The method according to claim 29, wherein B represents a C₁-C₁₂ dialkoxy radical.

34. The method according to claim 33, wherein B represents a C₁-C₁₂ dialkoxy radical, substituted with one or more trifluoromethyl radicals.

35. The method according to claim 29, wherein the diamine is of formula (IV): 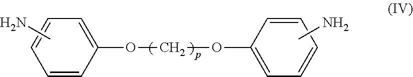
wherein p is an integer which varies from 1 to 12.

36. The method according to claim 35, wherein p is an integer which vanes from from 2 to 8, advantageously p has the value 5.

37. The method according to claim 35, wherein substituents NH₂ are in the para position.

38. The method according to claim 18, wherein the churning is of formula (V): 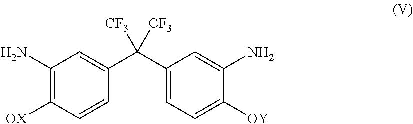
wherein X and Y represent independently of each other a hydrogen atom a C₁-C₁₂ alkyl, or a C₁-C₁₂ aralkyl.

39. The method according to claim 38, wherein both radicals X and Y each represent a hydrogen atom or a phenyl-octyl radical.

40. The method according to claim 18, wherein the additive by itself allows the making of a strong (zenithal and azimuthal) anchoring layer of the liquid crystal.

41. The method according to claim 40, wherein the additive by itself allows the making of a strong (zenithal and azimuthal) anchoring layer of the liquid crystal further advantageously with a pre-tilt of less than 5°.

42. The method according to claim 18, wherein the device comprises a planarization hardening layer located between the substrate and said at least one of the alignment layers.

43. The method according to claim 42, wherein said planarization hardening aver is based on a SiO₂/TiO₂ mixture, in said mixture the proportion of each of the oxides varies from 0% to 100% by weight, based on the total weight of the mixture.

44. The method according to claim 42, wherein said planarization hardening layer has a thickness comprised between 15 nm and 50 nm.

45. The method according to claim 18, wherein it includes an ultraviolet insolation step with a wavelength between 180 nm and 400 nm.

46. The method according to claim 18, wherein both stable textures without any applied fields differ by a torsion comprised between 150° and 180° in absolute value.

47. The method according to claim 18, wherein the switching between the stable textures is carried out by breaking the zenithal anchoring.

48. A method for enhancing bistable nematic liquid crystal devices, having a nematic liquid crystal layer placed between two plates (20,10), each plate including a strip (21,11), an electrode (22,12) (strip and electrode forming the substrate) and an alignment layer for a nematic liquid crystal (24,14), at least one of said alignment layers having:
low zenithal anchoring for said liquid crystal such that the breakage electric field is less than 15V/μm at room temperature
a pretilt angle comprised between 0° and 1°
medium or strong azimuthal anchoring characterized by an extrapolation length La<100 nm
wherein said at least one of the alignment layers is prepared by depositing a solution comprising a polymer, said polymer is a copolymer or a terpolymer derived from vinyl chloride and vinyl ethers of formula I 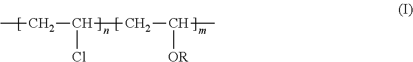
wherein
R represents an alkyl, alkoyl or aryl radical,
n and m vary from 0 to 1,
said enhancement consisting of using an additive in the solution containing the polymer I, said additive being selected from the group formed by aromatic polyimides, precursors of the aromatic polyamic acid type or a mixture of these compounds the mass percentage of the additive varying from 5% to 30% by weight, based on the total weight of said additive and of said polymer derived from vinyl chloride and vinyl ethers of formula I.

49. The method according to claim 48, wherein said polymer is a copolymer or a terpolymer derived from vinyl chloride and vinyl ethers of formula I wherein R represents the radical —CH₂CH(CH₃)₂.

50. The method according to claim 48, wherein said polymer is a copolymer or a terpolymer derived from vinyl chloride and vinyl ethers of formula I wherein n is comprised in the range: 0.5<n<0.9.

51. The method according to claim 48, wherein said polymer is a copolymer or a terpolymer derived from vinyl chloride and vinyl ethers of formula I wherein m is comprised in the range: 0.1<m<0.5.
